(19) United States
(12) Patent Application Publication
(10) Pub. No.: US 2002/0176160 A1
(43) Pub. Date: Nov. 28, 2002

(54) Microscope system

(75) Inventors: Akitoshi Suzuki, Yokohama-shi (JP); Yasushi Ogihara, Yokohama-shi (JP)

Correspondence Address: STAAS & HALSEY LLP, 700 11TH STREET, NW, SUITE 500, WASHINGTON, DC, 20001, US

(73) Assignee: Nikon Corporation, Tokyo (JP)

(21) Appl. No.: 10/108,337

(22) Filed: Mar. 29, 2002

(30) Foreign Application Priority Data
Mar. 30, 2001 (JP) P2001-099263

(51) Int. Cl. G02B 21/00

(52) U.S. Cl. 359/380

(57) ABSTRACT

A specific value for the magnification factor to be achieved for a specimen image is input to observe the specimen through a microscope. An optical system magnification factor and an electronic zoom magnification factor are calculated so as to achieve this specific value. When there are a plurality of optical systems with varying magnification factors, the optical system that achieves the calculated magnification factor is inserted at an observation optical path. When outputting image signals by capturing an image of the specimen formed by the optical system, the specimen image is obtained at the electronic zoom magnification factor that has been calculated. As a result, it is possible to obtain an image of the specimen which achieves a magnification factor determined in conformance to the product of the magnification factor of the optical system and the electronic zoom magnification factor.

### INCORPORATION BY REFERENCE

The disclosure of the following priority application is incorporated herein by reference: Japanese Patent Application No. 2001-99263 filed Mar. 13, 2001

### BACKGROUND OF THE INVENTION

1. Field of the Invention

The present invention relates to a microscope system utilized to observe a specimen and, more specifically, it relates to a microscope system capable of motor-drive control of the magnification factor at which the specimen is observed.

2. Description of the Related Art

There are microscope systems in the related art capable of switching the magnification factor at which a specimen is observed by implementing motor-drive control of a drive mechanism having a plurality of objective lenses with varying fixed powers of magnification, i.e., a motor-driven revolver device. For instance, when the magnification factor for observation is changed by switching between two objective lenses achieving magnifying powers of 10 and 40 respectively, the observer utilizes the motor-driven revolver device to position the objective lens with the magnifying power of 40 or 10 over the specimen.

However, such a microscope system in the related art does not allow observation at a magnification factor (e.g., a magnification factor of 43) that is different from the magnifying powers of the objective lenses (e.g., magnifying powers of 4, 10, 20, 40, 60 and 100).

In other words, there is a problem in that when the portion (a cell or the like) of the specimen to be observed is not sufficiently magnified through an objective lens with a magnifying power of 4 but the observation target is magnified excessively through an objective lens with a magnifying power of 10, the specimen cannot be observed at an optimal magnification factor between 4 and 10.

There are also microscope systems that include an intermediate variable-power optical system achieved through an optical zoom provided between the objective lens and the eyepiece lens. However, an optical zoom is expensive. In addition, a motor driven microscope requires a drive source for driving the optical zoom, and this may necessitate an increase in the size of the microscope system.

### SUMMARY OF THE INVENTION

An object of the present invention is to provide a microscope system, a microscope and an image capturing method to be adopted in a microscope, that achieve with ease an optimal magnification factor for observing a specimen.

A microscope system according to the present invention comprises an optical system holding member that holds a plurality of optical systems with different magnifying powers and inserts one of the plurality of optical systems at an optical path, an image-capturing element that captures an image of a specimen formed by the optical system and outputs an image signal, a setting device that sets an electronic zoom magnification factor for the image of the specimen captured by the image-capturing element and a control device that generates a specimen image at a display magnification factor by using the image signal output from the image-capturing element based upon the magnifying power of the optical system inserted at the optical path for specimen observation and the electronic zoom magnification factor.

This microscope system may further comprise an input device through which a specific value for the display magnification factor at which the specimen image is to be displayed is input and an inserting device that inserts the optical system selected for the specimen observation at the optical path by driving the optical system holding member. In such a case, the control device should control the inserting device and the setting device so as to match the display magnification factor with the specific value input through the input device.

From the individual magnifying powers of the plurality of optical systems, the control device may select a magnifying power with a value smaller than and closest to the specific value and calculate the ratio of the selected optical magnifying power and the specific value as the electronic zoom magnification factor.

It is desirable to set the maximum value for the electronic zoom magnification factor equal to the ratio of the two closest magnifying powers among the magnifying powers of the plurality of optical systems in the microscope system according to the present invention. A display image of the specimen may be generated by using an image signal read out over a readout range which corresponds to the electronic zoom magnification factor. Alternatively, a display image of the specimen may be generated by first temporarily storing in memory image signals read out from the image-capturing element and then reading out an image signal over a range corresponding to the electronic zoom magnification factor among the image signals read out from a memory.

The microscope system according to the present invention should preferably further comprise a correction device that, when the optical system inserted at the optical path is replaced with another optical system, corrects any decentering misalignment of the image occurring between the original optical system and the replacement optical system. The microscope system may further include a storage device that stores in memory a plurarity of decentering misalignment quantities each corresponding to the individual optical systems. More preferably, the positions at which images of a reference mark to be captured are formed by the plurality of optical systems respectively should be detected and the deviation between the positions at which the images are formed by the individual optical systems and the center of the image capturing screen should be stored in the storage device as the extents of the decentering misalignment. If the plurality of optical systems are not exchangeable, the extents of decentering misalignment manifesting in the individual optical systems are measured and stored in memory in advance at the storage device.

Another microscope system according to the present invention comprises an optical system holding member that holds a plurality of optical systems with different magnifying powers and inserts one of the plurality of optical systems at an optical path, an image-capturing element that captures an image of a specimen formed by the optical system and outputs an image signal, an input device through which a specific value for a magnification factor at which the specimen image is to be magnified is input, an arithmetic operation device that ascertains the magnifying power of the optical system inserted at the optical path and calculates an electronic zoom magnification factor for the specimen image based upon the specific value input through the input device and the magnifying power of the optical system having been ascertained and a control device that generates a specimen image at a display magnification factor by using the image signal output from the image-capturing element based upon the electronic zoom magnification factor calculated by the arithmetic operation device.

The present invention may also be adopted in a microscope that allows an image-capturing device to be mounted at a mounting unit thereof.

This microscope according to the present invention comprises a mounting unit at which an image-capturing device is mounted, an optical system holding member that holds a plurality of optical systems with different magnifying powers and inserts one of the plurality of optical systems at an optical path, an input device through which a specific value for a display magnification factor at which the specimen image is to be displayed is input, an arithmetic operation device that calculates an electronic zoom magnification factor for the specimen image based upon the specific value input through the input device and the magnifying power of the optical system inserted at the optical path to form the specimen on the image-capturing device and a control device that generates a specimen image at a display magnification factor that has been input by using the image signal output from the image-capturing device based upon the electronic zoom magnification factor calculated by the arithmetic operation device.

Alternatively, the microscope that allows an image-capturing device to be mounted at a mounting unit thereof may comprise the mounting unit at which the image-capturing device is mounted, an inserting device that inserts one of a plurality of optical systems with different magnifying powers for forming a specimen image on the image-capturing device at an optical path, an input device through which a specific value for a display magnification factor at which the specimen image is to be displayed is input, an arithmetic operation device that selects one of the plurality of optical systems based upon the specific value input through the input device and calculates an electronic zoom magnification factor for the specimen image based upon the magnifying power of the selected optical system and the input specific value and a control device that controls the inserting device so as to allow the selected optical system to be inserted at the optical path and generates a specimen image at the display magnification factor by using an image signal output from the image-capturing device based upon the electronic zoom magnification factor calculated by the arithmetic operation device.

In an image capturing method to be adopted in a microscope that displays a specimen image at a display magnification factor achieved based upon an optical magnification factor of an optical system and an electronic zoom magnification factor set for an image-capturing device, the display magnification factor is obtained, the optical system to be utilized is selected based upon the display magnification factor that has been obtained, the electronic zoom magnification factor is calculated based upon the optical magnification factor of the selected optical system and the display magnification factor having been obtained and the specimen image is generated at the display magnification factor having been obtained by using an image signal constituting an image of the specimen output from the image-capturing device.

According to the present invention, even when an optimal magnification factor (an optimal magnification factor at which a specimen image should be magnified) for observing the specimen differs from the magnifying power of the optical system, the specimen can be observed at the optimal magnification factor achieved in correspondence to the optical magnifying power and the electronic zoom magnification factor.

### BRIEF DESCRIPTION OF THE DRAWINGS

FIG. 1 illustrates the overall structure of the microscope system achieved in an embodiment;

FIG. 2 is provided to facilitate an explanation of the magnification factor set for a specimen image in the microscope system in the embodiment

FIG. 3A illustrates an operation menu and a magnification factor operating unit displayed on the screen of the display device;

FIG. 3B illustrates the magnification factor operating unit displayed on the screen of the display device

FIGS. 4A and 4B illustrate decentering misalignment that occurs when the magnifying optical system is switched;

FIG. 5 presents a flowchart of a procedure of the operation performed in the microscope system in the embodiment;

FIG. 6 presents a flowchart of a procedure of the operation performed in the microscope system in the embodiment;

FIG. 7 presents a flowchart of another example of a procedure of the operation that may be performed as an alternative to the procedure in FIG. 5 in the microscope system in the embodiment;

FIG. 8 is a perspective illustrating in detail the individual moving mechanisms in the microscope system in the embodiment;

FIG. 9 is a perspective showing the stage and the objective lenses in the microscope system in the embodiment; and

FIG. 10 is a perspective illustrating in detail the objective lens unit moving mechanism in the microscope system in the embodiment.

### DESCRIPTION OF THE PREFERRED EMBODIMENT

The following is a detailed explanation of an embodiment of the present invention, given in reference to the drawings.

A microscope system 10 achieved in the embodiment comprises a stage unit 12 on which a specimen 11 to be observed is placed, an illuminating unit 100 that illuminates the specimen 11, an image-forming unit 200 that forms a magnified image of the specimen 11, a CCD sensor 20 that captures the magnified image of the specimen 1, a control unit 21, a display device 22 and an input device 23.

The stage unit 12, the illuminating unit 100, the image-forming unit 200, the CCD sensor 20 and the control unit 21 are housed inside the casing (not shown) of the microscope system 10, whereas the display device 22 and the input device 23 are provided outside the casing.

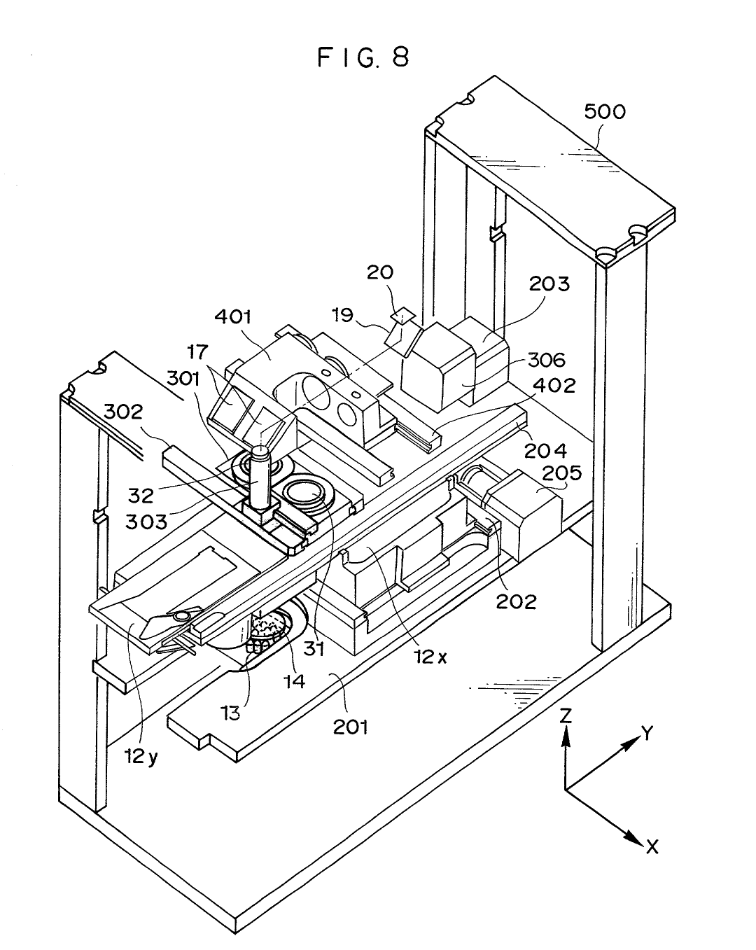

Inside the casing of the microscope system 10, the illuminating unit 100 is set under the stage unit 12 with the image-forming unit 200 and the CCD sensor 20 set above the stage unit 12. The microscope system 10 is a system which is utilized to observe the specimen 11 illuminated with transmitted light. The structure adopted within the casing is to be described in detail later in reference to FIGS. 8˜10.

Now, the components of the microscope system 10 achieved in the embodiment are individually explained.

The stage unit 12 is constituted of a motor-driven stage 12x that can be moved by a drive motor (not shown) along an x direction, a motor-driven stage 12y capable of moving along a y direction and an x counter and a y counter (not shown) that detect positions x and y of the motor-driven stages 12x and 12y respectively.

The illuminating unit 100, which is constituted of an illuminating light source 13, a diffusion plate 14 and a condenser lens 15, is set by aligning the optical axis of the condenser lens 15 along the z direction. At the illuminating unit 100, light emitted from the illuminating light source 13 is first diffused at the diffusion plate 14 and then condensed at the condenser lens 15 before entering the specimen 11. The light having entered the specimen 11 from the illuminating unit 100 is transmitted through the specimen 11 and is guided to the image-forming unit 200.

The illuminating light source 13 may be constituted of an array of a plurality of LED elements achieving output wavelengths equal to one another. Alternatively, the illuminating light source 13 may be constituted by using a plurality of LED elements with varying output wavelengths. The illuminating light source 13 may otherwise be constituted of elements other than LED elements, such as a halogen lamp which is often used in this type of microscope system in the related art, for instance.

The image-forming unit 200 is constituted of an objective lens unit 16, a mirror 17, a tube lens unit 18 and a mirror 19. At the image-forming unit 200, the transmitted light from the specimen 11 is converted to parallel light via the objective lens unit 16 and an image is formed at a specific surface 18a, i.e., the image-capturing surface of the CCD sensor 20 via the tube lens unit 18.

At the image-forming unit 200, the optical path (hereafter referred to as an “observation optical path 10a”) through which the transmitted light from the specimen 11 travels to form the image at the specific surface 18a, is deflected by 90° by the mirror 17 on a parallel optical path between the objective lens unit 16 and the tube lens unit 18 and is also deflected by 90° by the controller 19 in the image forming optical path between the tube lens unit 18 and the specific surface 18a.

In other words, the part of the observation optical path 10a extending between the specimen 11 and the mirror 17 (over the area where the objective lens unit 16 is provided) is parallel to the z direction, the part of the observation optical path 10a extending between the mirrors 17 and 19 (over the area where the tube lens unit 18 is provided) is parallel to the x direction and the part of the observation optical path 10a extending between the mirror 19 and the specific surface 18a is parallel to the z direction.

The mirror 17 can be moved out of the observation optical path 10a. By moving the mirror 17 out of the observation optical path 10a, the parallel light from the objective lens unit 16 can be guided to another optical system (not shown). The other optical system in this case may be, for instance, an optical system provided to allow observation of a wider range (the entire preparation) that contains the specimen 11. The mirror 19 is an optical element provided to return the image having been reversed at the mirror 17 to its original orientation.

Now, the objective lens unit 16 and the tube lens unit 18 are described in detail.

The objective lens unit 16 includes an objective lens 31 with a magnifying power of 40 and an objective lens 32 with a magnifying power of 10. The optical axes of the objective lenses 31 and 32 extend along the z direction.

At the objective lens unit 16, provided is a supporting member (not shown) that supports the objective lenses 31 and 32 over a predetermined distance from each other along the x direction and can be moved by a drive motor (not shown) along the x direction. By moving this supporting member, either one of the objective lenses 31 and 32 can be inserted at the observation optical path 10a.

A sensor 33 is provided out of the observation optical path 10a at the objective lens unit 16. This sensor 33 detects the type of objective lens (31 or 32) currently inserted at the observation optical path 10a.

The tube lens unit 18 includes a tube lens 34 with a magnifying power of ½ and a tube lens 35 with a magnifying power of 1. The optical axes of these tube lenses 34 and 35 extend along the x direction.

At the tube lens unit 18A, provided is a supporting member (not shown) that supports the tube lenses 34 and 35 over a predetermined distance from each other along the z direction and can be moved by a drive motor (not shown) along the z direction. By moving this supporting member, either one of the tube lenses 34 and 35 can be inserted at the observation optical path 10a.

A sensor 36 is provided out of the observation optical path 10a at the tube lens unit 18. This sensor 36 detects whether the tube lens 34 or the tube lens 35 is currently inserted at the observation optical path 10a.

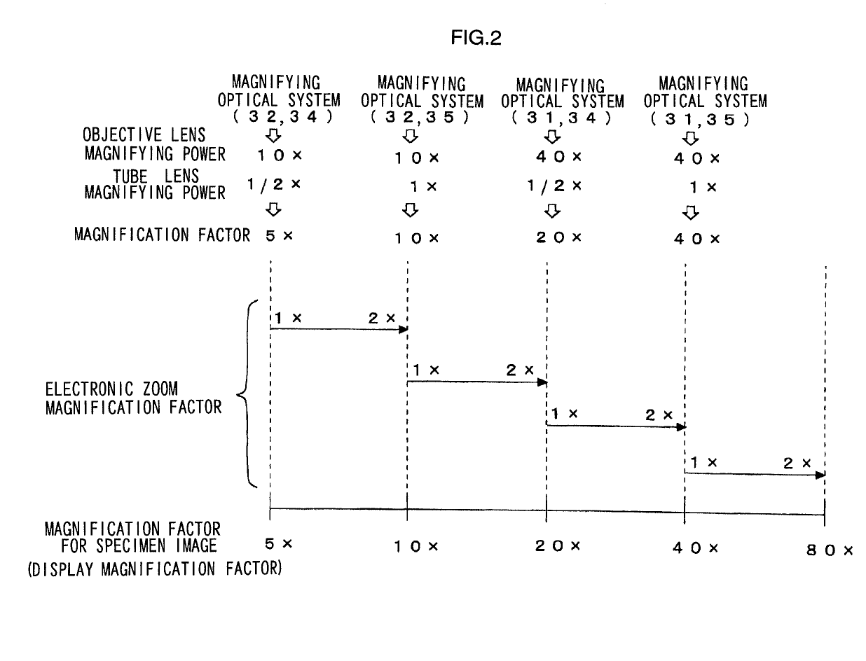

In the microscope system 10 achieved in the embodiment which includes the objective lens unit 16 and the tube lens unit 18 structured as described above, an image of the specimen 11 magnified at a magnification factor of 5 is formed at the specific surface 18a when the objective lens 32 with the magnifying power of 10 and the tube lens 34 with the magnifying power of ½ are inserted at the observation optical path 10a. The optical system achieving the magnification factor of 5, i.e., the optical system constituted by combining the objective lens 32 and the tube lens 34, is referred to as a magnifying optical system (32, 34) as necessary (see FIG. 2).

When the objective lens 32 with the magnifying power of 10 and the tube lens 35 with the magnifying power of 1 are inserted at the observation optical path 10a, on the other hand, an image of the specimen 11 magnified at a magnification factor of 10 is formed at the specific surface 18a. The optical system achieving the magnification factor of 10, i.e., the optical system constituted by combining the objective lens 32 and the tube lens 35, is referred to as a magnifying optical system (32, 35) as necessary (see FIG. 2).

When the objective lens 31 with the magnifying power of 40 and the tube lens 34 with the magnifying power of ½ are inserted at the observation optical path 10a, on the other hand, an image of the specimen 11 magnified at a magnification factor of 20 is formed at the specific surface 18a. The optical system achieving the magnification factor of 20, i.e., the optical system constituted by combining the objective lens 31 and the tube lens 34, is referred to as a magnifying optical system (31, 34) as necessary (see FIG. 2).

When the objective lens 31 with the magnifying power of 40 and the tube lens 35 with the magnifying power of 1 are inserted at the observation optical path 10a, an image of the specimen 11 magnified at a magnification factor of 40 is formed at the specific surface 18a. The optical system achieving the magnification factor of 40, i.e., the optical system constituted by combining the objective lens 31 and the tube lens 35, is referred to as a magnifying optical system (31, 35) as necessary (see FIG. 2).

In the microscope system 10 in the embodiment, any one of the four different magnifying optical systems is achieved to form a magnified image at the specific surface 18a by selecting a specific combination of one of the two objective lenses 31 and 32 and one of the two tube lenses 34 and 35 to be inserted at the observation optical path 10a (see FIG. 2). The four magnifying optical systems achieve magnification factors different from one another.

As shown in FIG. 2, the magnification factors achieved through the four different magnifying optical systems are, from the smallest to the largest (5, 10, 20, 40) and the ratio of two closest magnification factors, i.e., the ratio B/S of the larger magnification factor B (e.g., 20) to the smaller magnification factor S(e.g., 10) is always the same. B/S is 2 at all times in the microscope system 10 in the embodiment.

The CCD sensor 20, which captures the magnified image formed at the specific surface 18a in the microscope system 10 in the embodiment, is a two-dimensional image-capturing element constituted by using a CCD (charge-coupled device) and includes a plurality of light-receiving portions two-dimensionally arrayed along the x and y directions. The CCD sensor 20 captures the magnified image of the specimen 11 and outputs image signals.

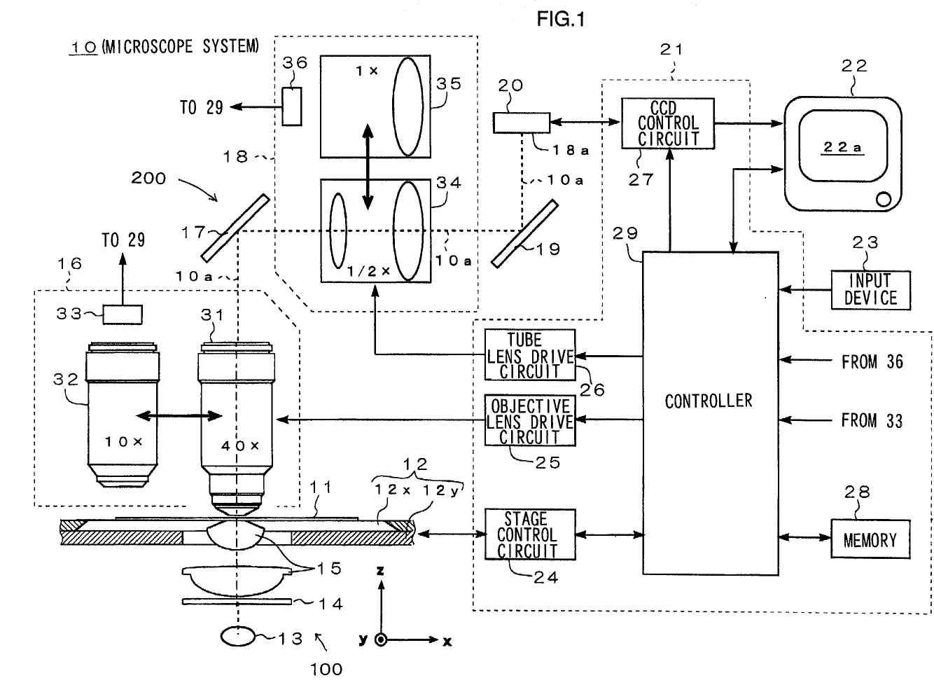

The control unit 21 in FIG. 1 is constituted of a stage control circuit 24 connected to the stage unit 12, an objective lens drive circuit 25 connected to the objective lens unit 16, a tube lens drive circuit 26 connected to the tube lens unit 18, a CCD control circuit 27 connected to the CCD sensor 20 and the display device 22, a memory 28 and a controller 29. The display device 22, the input device 23, the sensor 33 at the objective lens unit 16 and the sensor 36 at the tube lens unit 18, as well as the various circuits (24˜27) and the memory 28 constituting the control unit 21, are connected to the controller 29.

Based upon a control signal provided by the controller 29, the stage control circuit 24 rotates the drive motors (not shown) that drives the stage unit 12 to move the motor-driven stages 12x and 12y along the x direction and the y direction respectively. The stage control circuit 24 reads the values at the x counter and the y counter (not shown) of the stage unit 12 and outputs signals indicating positions x and y of the motor-driven stages 12x and 12y to the controller 29.

The objective lens drive circuit 25 rotates the drive motor (not shown) which drives the objective lens unit 16 based upon a control signal provided by the controller 29 to move the supporting member (not shown) along the x direction together with the objective lenses 31 and 32. As a result, either the objective lens 31 or the objective lens 32 is positioned at the observation optical path 10a. It is to be noted that a signal indicating either the objective lens 31 or the objective lens 32 inserted at the observation optical path 10a, i.e., a detection signal from the sensor 33, is output from the sensor 33 to the controller 29.

The tube lens drive circuit 26 rotates the drive motor (not shown) which drives the tube lens unit 18 based upon a control signal provided by the controller 29 to move the supporting member (not shown) along the x direction together with the tube lenses 34 and 35. For purposes of simplification, the tube lenses 34 and 35 are shown side-by-side along the z direction in FIG. 1. As a result, either the tube lens 34 or the tube lens 35 is positioned at the observation optical path 10a. It is to be noted that a signal indicating either the tube lens 34 or 35 inserted at the observation optical path 10a, i.e., a detection signal from the sensor 36, is output from the sensor 36 to the controller 29.

The CCD control circuit 27 outputs a timing signal to the CCD sensor 20 based upon a control signal provided by the controller 29. This timing signal is a clock signal used to transfer the electrical charges stored at the individual light-receiving portions of the CCD sensor 20. At the CCD sensor 20, the electrical charges are transferred in response to the timing signal from the CCD control circuit 27 to output image signals (analog signals).

The CCD control circuit 27 sets an electronic zoom magnification factor at which the image signals from the CCD sensor 20 are to be output based upon a control signal provided by the controller 29. As explained earlier, the four different magnifying optical systems (see FIG. 2) can be achieved at the microscope system 10 in the embodiment, with the closest magnification factors achieving a constant ratio B/S of 2. For this reason, the electronic zoom magnification factor should be set at a value equal to or smaller than 2 and equal to or larger than 1. However, the electronic zoom magnification factor may be set with no regard to the ratio B/S of the closest magnification factors.

Thus, image signals having undergone electrical signal processing implemented based upon the electronic zoom magnification factor set by the CCD control circuit 27 are output from the CCD sensor 20 to the CCD control circuit 27. These image signals constitute a specimen image.

The CCD control circuit 27 amplifies the analog image signals from the CCD sensor 20, converts them to digital signals and outputs the digitized signals to the display device 22. As a result, the specimen image constituted of the image signals is displayed over almost the entirety of a screen 22a of the display device 22. It is possible to obtain a dynamic image by reading the image from the CCD sensor 20 at a predetermined sampling rate as well.

The display magnification factor at which the specimen image is displayed at the screen 22a of the display device 22 is determined in correspondence to the product of the magnification factor (5, 10, 20 or 40) of the magnifying optical system constituted of the lenses inserted at the observation optical path 10a when the CCD sensor 20 captures an image of the specimen 11 and the electronic zoom magnification factor (1˜2) set when the CCD sensor 20 outputs the image signals (see FIG. 2).

For instance, when the magnifying optical system (32, 34) achieving the magnification factor of 5 is inserted at the observation optical path 10a, the display magnification factor for the specimen image can be varied within the range of 5˜10 by changing the setting for the electronic zoom magnification between 1 and 2. Namely, a magnification factor between the magnification factor 5 zoom realized through the magnifying optical system (32, 34) and the magnification factor 10 zoom realized through the magnifying optical system (32, 35) can be set through an interpolation achieved in correspondence to the electronic zoom magnification factor.

When the magnifying optical system (32, 35) achieving the magnification factor of 10 is inserted at the observation optical path 10a, the display magnification factor for the specimen image can be varied within the range of 10˜20 by changing the setting for the electronic zoom magnification between 1 and 2. Namely, a magnification factor between the magnification factor 10 zoom realized through the magnifying optical system (32, 35) and the magnification factor 20 zoom realized through the magnifying optical system (31, 34) can be set through an interpolation achieved in correspondence to the electronic zoom magnification factor.

When the magnifying optical system (31, 34) achieving the magnification factor of 20 is inserted at the observation optical path 10a, the display magnification factor for the specimen image can be varied within the range of 20˜40 by changing the setting for the electronic zoom magnification between 1 and 2. Namely, a magnification factor between the magnification factor 20 zoom realized through the magnifying optical system (31, 34) and the magnification factor 40 zoom realized through the magnifying optical system (31, 35) can be set through an interpolation achieved in correspondence to the electronic zoom magnification factor.

When the magnifying optical system (31, 35) achieving the magnification factor of 40 is inserted at the observation optical path 10a, the display magnification factor for the specimen image can be varied within the range of 40˜80 by changing the setting for the electronic zoom magnification between 1 and 2.

As described above, the display magnification factor for the specimen image can be adjusted to any value within the range of 5˜80 by controlling the combination of the magnification factor (5, 10, 20 or 40) achieved through one of the four different magnifying optical systems and the electronic zoom magnification factor (1˜2).

The magnification factor for the specimen image (hereafter referred to as the display magnification factor) is adjusted in conformance to the specific value setting for the specimen image display magnification factor input from the input device 23 to the controller 29. The magnification factor adjustment is to be described in detail later.

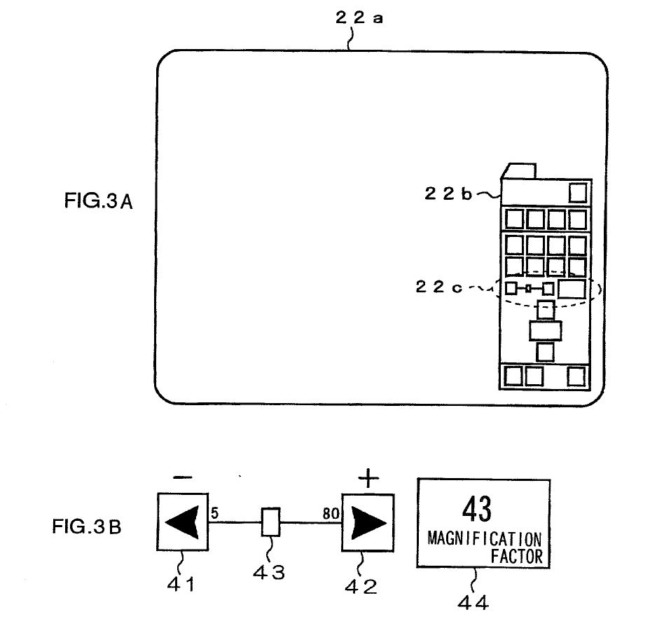

Now, the input of the specific value from the input device 23 to the controller 29 is explained. When inputting the specific value setting for the specimen image display magnification factor, an operation menu 22b (see FIG. 3A) is brought up on display at the screen 22a of the display device 22. By operating a magnification factor specifying unit 22c in the operation menu 22b, the specific value setting for the specimen image display magnification factor can be input. The magnification factor specifying unit 22c can be operated through the input device 23.

As shown in FIG. 3B, the magnification factor specifying unit 22c includes a DOWN button 41 for lowering the magnification factor, an UP button 42 for raising the magnification factor, a slider 43 and an input box 44. By operating the DOWN button 41 or the UP button 42 to decrease/increase the magnification factor in increments of a magnification factor of 1, by moving the slider 43 to the left or the right or directly entering a value at the input box 44 through the input device 23, any value within a magnification factor range of 5 through 80 can be input to the controller 29 as the specific value setting for the specimen image display magnification factor.

When replacing the magnifying optical system inserted at the observation optical path 10a with another magnifying optical system in order to adjust the display magnification factor for the specimen image, at least either the objective lenses 31 and 32 or the tube lenses 34 and 35 are moved along a direction intersecting the observation optical path 10a together with the corresponding supporting member (not shown) and are positioned.

However, if the distance between the objective lens 31 and the objective lens 32 mounted at the supporting member does not match the distance over which the supporting member is caused to move by the objective lens drive circuit 25 or if the distance between the tube lens 34 and the tube lens 35 mounted at the supporting member does not match the distance over which the supporting member is caused to move by the tube lens drive circuit 26, the specimen image displayed at the screen 22a of the display device 22 becomes offset. In other words, a decentering misalignment occurs in the image.

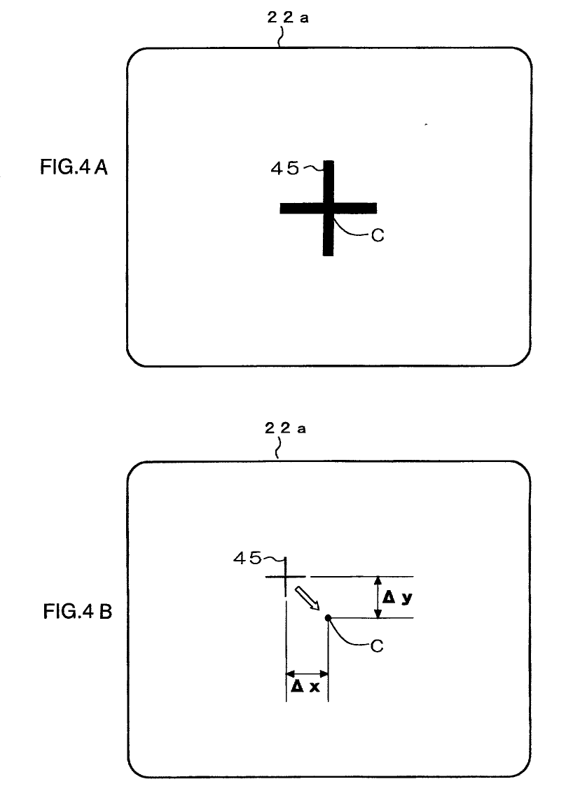

The occurrence of such a decentering misalignment is explained in reference to FIG. 4 by using an example in which the objective lenses 31 and 32 are moved so as to replace the magnifying optical system (31, 34) inserted at the observation optical path 10a with another magnifying optical system (32, 34). The specimen 11 used in this example is a test pattern constituted of cross lines 45.

As shown in FIG. 4A, if the cross lines 45 are positioned at the center C of the screen 22a while the magnifying optical system (31, 34) is inserted at the observation optical path 10a, and then the magnifying optical system (31, 34) is replaced with the magnifying optical system (32, 34) by moving the objective lenses 31 and 32, the cross lines 45 become offset from the center C of the screen 22a as illustrated in FIG. 4B. The offset quantities Δ x and Δ y represent the decentering misalignment manifesting in this situation.

The decentering misalignment Δ x and Δ y, which occurs when the magnifying optical system is replaced as described above, can be corrected by controlling the motor-driven stages 12 x and 12 y and moving the specimen 11 over a distance which will cancel out the decentering misalignment Δ x and Δ y. Details of this correction are to be described later. The distances over which the motor-driven stages 12 x and 12 y must be moved in order to correct the decentering misalignment Δ x and Δ y are constant in the microscope system 10, since the objective lenses 31 and 32 and the tube lenses 34 and 35 are secured to the respective supporting members.

In the microscope system 10, stored in the memory 28 in advance are offset quantities Δ x 1 and Δ y 1 representing the decentering misalignment which occurs when the magnifying optical system is replaced by moving the objective lenses 31 and 32 and offset quantities Δ x 2 and Δ y 2 representing the decentering misalignment which occurs when the magnifying optical system is replaced by moving the tube lenses 34 and 35.

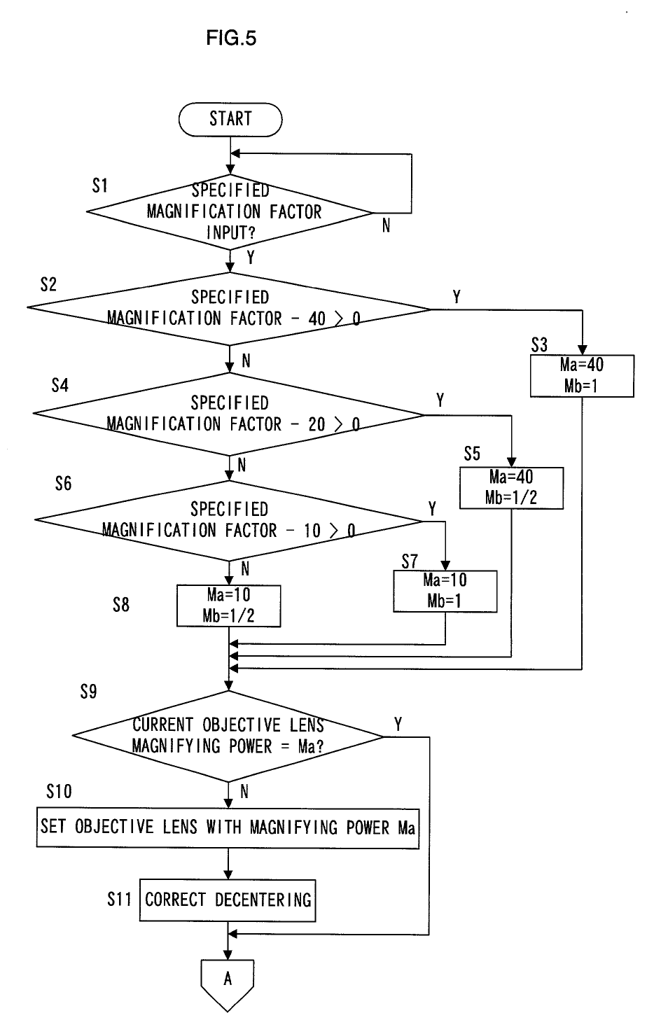

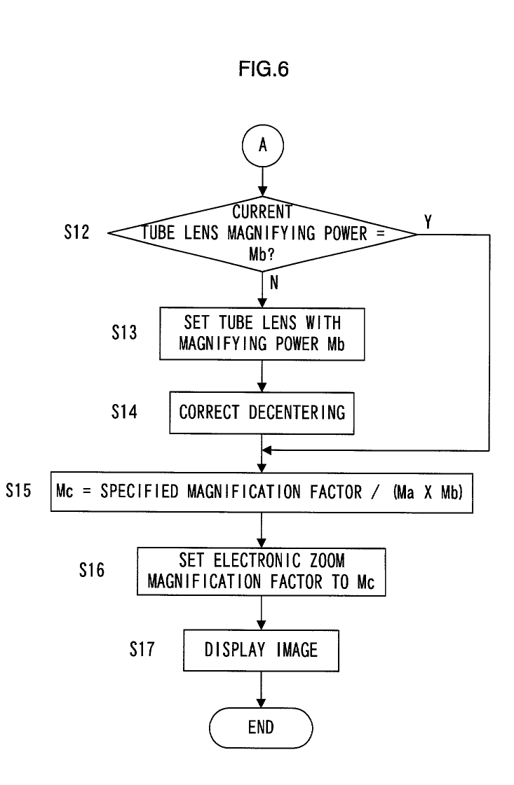

The operation of the microscope system 10 structured as described above is now explained in reference to the flowchart presented in FIGS. 5 and 6. As power to the microscope system 10 is turned on, the controller 29 initializes the various components of the microscope system 10 and starts the control which is implemented as shown in the flowchart in FIGS. 5 and 6.

When a given value within the range of magnification factors 5 through 80 is input as the specific value setting for a the specimen image display magnification factor through the magnification factor specifying unit 22c in the operation menu 22b displayed in the screen 22a of the display device 22 (see FIG. 3A) and the input device 23, an affirmative decision is made in step S1 and the operation proceeds to step S2.

Hereafter, the specific value setting for the specimen image display magnification factor is to be referred to as a “specified magnification factor” and the magnification factor achieved by the magnifying optical system is to be referred to as an “optical magnification factor”. The controller 29 sequentially compares the optical magnification factors with the specified magnification factor, starting with the largest magnification factor (40) and moving on to the smaller magnification factors (step S2, S4 and S6), in order to select one of the four optical magnification factors (5, 10, 20 and 40) that is to be achieved by the magnifying optical system inserted at the observation optical path 10a. If the specified magnification factor is larger than the optical magnification factor (40), an affirmative decision is made in step S2 and the operation proceeds to step S3. In step S3, 40 is selected as the optical magnification factor to be achieved by the magnifying optical system inserted at the observation optical path 10a. The optical magnification factor 40 is achieved through the combination of the objective lens 31 with the magnifying power of 40 and the tube lens 35 with the magnifying power of 1. Accordingly, 40 is entered as a variable Ma representing the magnifying power of the objective lens and 1 is entered as a variable Mb representing the magnifying power of the tube lens.

If, on the other hand, the specified magnification factor is equal to or smaller than the optical magnification factor (40), a negative decision is made in step S2 and the operation proceeds to step S4. If the specified magnification factor is higher than the optical magnification factor (20), an affirmative decision is made in step S4 and the operation proceeds to step S5. In step S5, 20 is selected for the optical magnification factor to be achieved by the magnifying optical system inserted at the observation optical path 10a. An optical magnification factor of 20 is achieved through the combination of the objective lens 31 with the magnifying power of 40 and the tube lens 34 with the magnifying power of ½. Accordingly, 40 is entered for the variable Ma which indicates the magnifying power of the objective lens and ½ is entered for the variable Mb which indicates the magnifying power of the tube lens.

If the specified magnification factor is equal to or smaller than the optical magnification factor (20), a negative decision is made in step S4 and the operation proceeds to step S6. If the specified magnification factor is larger than the optical magnification factor (10), an affirmative decision is made in step S6 and the operation proceeds to step S7. In step S7, 10 is selected for the optical magnification factor to be achieved by the magnifying optical system inserted at the observation optical path 10a. An optical magnification factor of 10 is achieved through the combination of the objective lens 32 with the magnifying power of 10 and the tube lens 35 with the magnifying power of 1. Accordingly, 10 is entered for the variable Ma which indicates the magnifying power of the objective lens and 1 is entered for the variable Mb which indicates the magnifying power of the tube lens.

If the specified magnification factor is equal to or smaller than the optical magnification factor (10), a negative decision is made in step S6 and the operation proceeds to step S8. 5 is then selected for the optical magnification factor to be achieved by the magnifying optical system inserted at the observation optical path 10a. An optical magnification factor of 5 is achieved through the combination of the objective lens 32 with the magnifying power of 10 and the tube lens 34 with the magnifying power of ½. Accordingly, 10 is entered for the variable Ma which indicates the magnifying power of the objective lens and ½ is entered for the variable Mb which indicates the magnifying power of the tube lens.

By executing the processing in steps S2˜S8 as described above, a single optical magnification factor (Ma×Mb) that is smaller than the specified magnification factor and manifests the smallest difference relative to the specified magnification factor is selected from the four optical magnification factors (5, 10, 20 and 40).

As the explanation given above clearly states, optical magnification factor to be achieved by the magnifying optical system and the combination of the objective lens and the tube lens are selected by the controller 29.

The controller 29 makes a decision as to whether or not the objective lens (31 or 32) with the magnifying power Ma is currently inserted at the observation optical path 10a to constitute the magnifying optical system achieving the selected optical magnification factor (Ma×Mb) (step S9) This judgement is performed based upon the detection signal from the sensor 33 of the objective lens unit 16.

If the objective lens (31 or 32) with the selected magnifying power Ma is positioned out of the observation optical path 10a, a negative decision is made in step S9 and the operation proceeds to step S10. In order to insert the objective lens (31 or 32) with the selected magnifying power Ma at the observation optical path 10a, the controller 29 outputs a control signal to the objective lens drive circuit 25 so as to move the objective lenses 31 and 32 along the x direction.

In step S11, the controller 29 implements control on the stage control circuit 24 based upon the decentering misalignment quantities Δ x 1 and Δ y 1 read out from the memory 28 where they have been stored in order to correct the decentering misalignment that occurs when the objective lenses 31 and 32 are moved. As a result, the motor-driven stages 12x and 12y are moved along the x direction and the y direction by the distances corresponding to the decentering misalignment quantities Δ x 1 and Δ y 1 respectively and thus, the correction of the decentering attributable to the displacement of the objective lenses 31 and 32 ends.

In step S9, an affirmative decision is made if the objective lens (31 or 32) with the selected magnifying power Ma is already inserted at the observation optical path 10a. Since it is not necessary to switch the objective lenses 31 and 32 in this case, the operation proceeds to step S12 (see FIG. 6) without executing the processing in steps S10 and S11.

In step S12, the controller 29 makes a decision as to whether or not the tube lens (34 or 35) with the magnifying power Mb is currently inserted at the observation optical path 10a to constitute the magnifying optical system achieving the selected optical magnification factor (Ma×Mb). This judgement is performed based upon the detection signal from the sensor 36 of the tube lens unit 18.

If the tube lens (34 or 35) with the selected magnifying power Mb is positioned out of the observation optical path 10a, a negative decision is made in step S12 and the operation proceeds to step S13. In step S13, in order to insert the tube lens (34 or 35) with the selected magnifying power Mb at the observation optical path 10a, the controller 29 outputs a control signal to the tube lens drive circuit 26 so as to move the tube lenses 34 and 35 along the x direction (step S13) .

In step S14, the controller 29 corrects the decentering misalignment that occurs when the tube lenses 34 and 35 are moved. Namely, the controller 29 implements control on the stage control circuit 24 based upon the decentering misalignment quantities Δ x 2 and Δ y 2 read out from the memory 28 where they have been stored. As a result, the motor-driven stages 12x and 12y are moved along the x direction and the y direction by the distances corresponding to the decentering misalignment quantities Δ x 2 and Δ y 2 respectively and thus, the correction of the decentering attributable to displacement of the tube lenses 34 and 35 ends.

In step S12, an affirmative decision is made if the tube lens (34 or 35) with the selected magnifying power Mb is already inserted at the observation optical path 10a. Since it is not necessary to switch the tube lens 34 and 35 in this case, the operation proceeds to step S15 without executing the processing in steps S13 and S14.

By executing the processing in steps S9˜S11 (FIG. 5) and steps S12˜S14 (FIG. 6) as described above, the magnifying optical system achieving the selected optical magnification factor (Ma×Mb) is inserted at the observation optical path 10a and, at the same time, the decentering misalignment is corrected. Thus a desirable magnified image of the specimen 11 is formed at the specific surface 18a, i.e., the image-capturing surface of the CCD sensor 20, at the magnification factor corresponding to the selected optical magnification factor (Ma×Mb).

In step S15, the ratio Mc of the specified magnification factor to the selected optical magnification factor (Ma×Mb) is calculated by the controller 29, and the controller 29 then implements control on the CCD control circuit 27 based upon the ratio Mc resulting from the calculation in step S16. Thus, the electronic zoom magnification factor at which image signals are output from the CCD sensor 20 is set to a value equal to the calculated ratio Mc.

Finally, in step S17, the controller 29 implements control on the CCD control circuit 27 to display the specimen image in the screen 22a of the display device 22. At this time, the specimen image is displayed in the screen 22a of the display device 22 at the magnification factor obtained through the adjustment implemented in steps S2˜S16.

The magnified image of the specimen is displayed in the display screen 22a by reading out pixel signals over n/Mc rows×m/Mc columns at the center of the image-capturing area among the pixel signals at the pixels provided over n rows×m columns at the CCD 20 based upon the electronic zoom magnification factor Mc and then augmenting the image signals thus read out by the factor of Mc both longitudinally and laterally. Alternatively, all the pixel signals at the pixels provided over n rows×m columns at the CCD 20 may be read out and temporarily stored in a buffer memory so as to display a magnified image of the specimen in the display screen 22a by executing electronic zoom processing on the image signals having been stored on a temporary basis.

The display magnification factor for the specimen image thus obtained is determined in correspondence to the product of the selected optical magnification factor (Ma×Mb) and the electronic zoom magnification factor (ratio Mc) . This value is the specified magnification factor input in step S1 (see FIG. 5).

For instance, if a magnification factor “43” is specified, 40 is selected for the optical magnification factor (Ma×Mb) to be achieved by the magnifying optical system inserted at the observation optical path 10a and the electronic zoom magnification factor (ratio Mc) is calculated to be 1.075.

As explained above, even when the optimal magnification factor for the specimen image i.e., the specified magnification factor, is different from the magnification factor achieved by the magnifying optical system, the optimal magnification factor, i.e., the specified magnification factor, can be achieved through motor-drive control in correspondence to the product of the magnification factor (Ma×Mb) achieved by the magnifying optical system inserted at the observation optical path 10a and the electronic zoom magnification factor (ratio Mc) in the microscope system 10 in the embodiment. In other words, the specimen 11 can be observed at the optimal specified magnification factor which is different from the magnification factor achieved by the magnifying optical system.

The microscope system 10 in the embodiments achieves the following advantages.

(1) Since an electronic zoom magnification factor within a range of 1˜2 is adopted in addition to utilizing the objective lenses (with the magnifying powers of 10 and 40) and the tube lenses (with the magnifying powers of 1 and ½), the specimen 11 can be observed over a wide and continuous magnification factor range of 5˜80.

(2) Since the electronic zoom function of the CCD sensor 20 is utilized, it is not necessary to mount an optical zoom mechanism at the magnifying optical system, and it thus, the system does not become excessively large and the production costs can be minimized.

(3) The magnifying optical system to be inserted at the observation optical path 10a is selected so as to achieve an optical magnification factor (Ma×Mb) that is smaller than the specified magnification factor and manifests the least difference relative to the specified magnification factor. Then, the electronic zoom magnification factor is calculated based upon the ratio Mc of the specified magnification factor to the selected optical magnification factor (Ma×Mb) . As a result, the magnification factor (display magnification factor) of the specimen image can be adjusted by using the smallest possible electronic zoom magnification factor (1˜2) while making the most of the availability of the different magnification factors (5, 10, 20 and 40) achieved by the four magnifying optical systems.

(4) Since any value between 1˜2 can be set for the electronic zoom magnification factor, the extent of inconsistency in the resolution of the specimen image attributable to the electronic zoom magnification factor setting can be minimized and thus, the specimen image is allowed to maintain good resolution.

(5) Since any decentering misalignment that occurs when the objective lenses 31 and 32 or the tube lens 34 and 35 are switched is corrected during the zooming operation performed to adjust the magnification factor for the specimen image, the center of the specimen image does not become offset. In other words, accurate zooming is achieved while maintaining a fixed central position on the screen 22a of the display device 22.

(6) Since the magnifying optical system is constituted by combining one of the objective lenses 31 and 32 with one of the tube lenses 34 and 35 in the microscope system 10 in the embodiment, observation conducted at a low magnification factor can be achieved with a good NA.

### Example of Variation

While an explanation is given above in reference to the embodiment on an example in which the two objective lenses (31 and 32) are secured to a supporting member, the present invention may be adopted in conjunction with detachable objective lenses instead.

For instance, when there are two detachable objective lenses, a controller 29 may control the display magnification factor as described below.

As the magnifying powers (M1 and M2) of the objective lenses mounted at the supporting member of the objective lens unit 16 are input through the input device 23, the controller 29 calculates four different magnification factors (optical magnification factors) that can be achieved by magnifying optical systems realized through different combinations of the magnifying powers (M1 and M2) having been input and the magnifying powers of the tube lenses (34 and 35). The results of the calculation are sequentially entered as variables K 1, K 2, K 3 and K 4, from the largest optical magnification factor toward the smaller magnification factors.

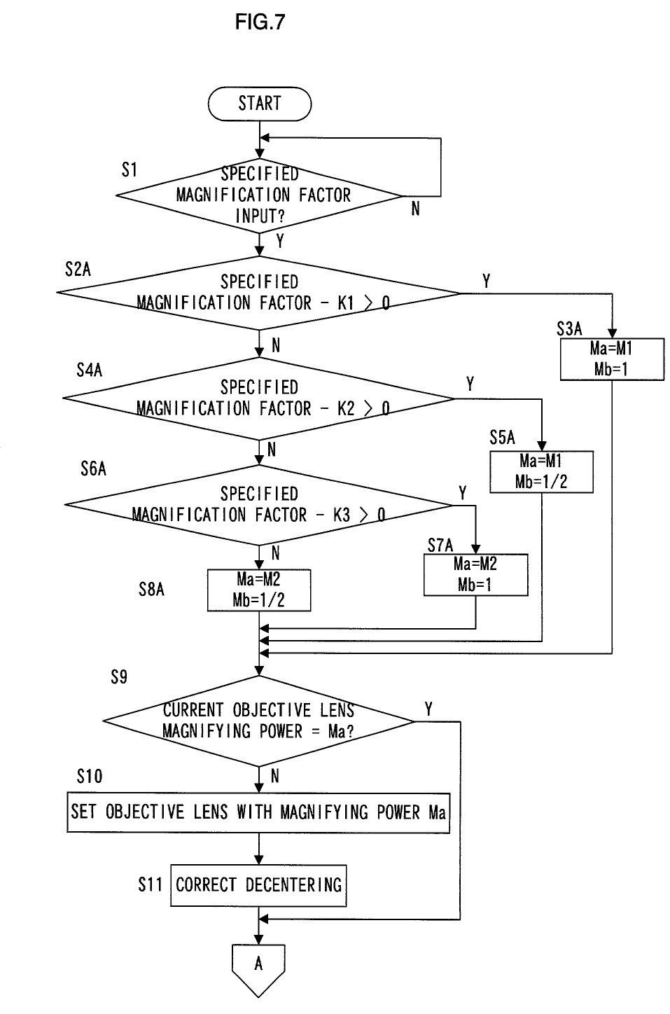

FIG. 7 presents a flowchart of the processing procedure of a program executed by the controller 29 in the microscope system achieved in this variation. “40”, “20” and “10” in steps S2, S4 and S6 in FIG. 5 are respectively replaced by “K 1”, “K 2” and “K 3” in steps S2A, S4A and S6A in FIG. 7. “40” in steps S3 and S5 in FIG. 5 is replaced by “M1” in steps S3A and S5A in FIG. 7. “10” in steps S7 and S8 is replaced by “M2” in steps S7A and S8A in FIG. 7. By controlling the display magnification factor with the controller 29 as shown in the flowchart (M1>M2) in FIG. 7, advantages similar to those realized in the embodiment explained earlier are achieved.

If the extent of decentering misalignment changes when two new objective lenses are mounted, the decentering misalignment should be measured in advance and the measurement data should be stored in the memory 28 as explained below.

The decentering misalignment measurement is performed by using a test pattern (see FIG. 4A) constituted of the cross lines 45 as the specimen 11. First, with one of the objective lenses inserted at the observation optical path 10a, the cross lines 45 are positioned at the center C of the screen 22a (see FIG. 4A) and the current position at this point is input. Next, when the first objective lens is replaced with the other objective lens, the cross lines 45 become offset from the center C of the screen 22a (see FIG. 4B), and accordingly, the cross lines 45 are positioned at the center C of the screen 22a again and the current position at this point is entered.

Once the current position inputs are completed, the controller 29 reads and stores in memory the values at the x and y counters of the stage unit 12. Thus, the differences (Δ x and Δ y) between the values at the x and y counters obtained through the two current position inputs are stored in the memory 28 as the decentering misalignment. By measuring the decentering misalignment and storing it in the memory 28 in advance in this manner, accurate decentering correction can be achieved when using detachable objective lenses as well.

While the magnifying optical system is constituted by combining an objective lens and a tube lens in the embodiment described above, an optical system constituted by combining a plurality of objective lenses may be utilized instead. In addition, while a magnifying optical system is employed in the example explained above, the present invention may also be adopted in conjunction with a reducing optical system achieved by utilizing an objective lens with a magnifying power of 0.5.

While four magnifying optical systems with varying magnification factors are achieved through different combinations of two objective lenses (31 and 32) and two tube lenses (34 and 35) in the embodiment described above, the present invention is not limited to this example.

For instance, a plurality of magnifying optical systems with varying magnification factors may be achieved through different combinations of a single objective lens and a plurality of tube lenses. A plurality of magnifying optical systems with varying magnification factors may be achieved through different combinations of a plurality of objective lenses and a single tube lens, instead. In addition, a magnifying lens may be utilized in place of a tube lens.

While an explanation is given above in reference to the embodiment on an example in which the specimen 11 is observed in the microscope system 10 illuminated with transmitted light, the present invention may be adopted in a microscope system in which the specimen is illuminated through reflected illumination (epi-illumination) as well.

While an explanation is given above in reference to the embodiment on an example in which the microscope system 10 does not include an eyepiece lens, the present invention may be adopted in a microscope system which enables observation of a specimen through an eyepiece lens as does a standard microscope.

While an explanation is given above in reference to the embodiment on an example in which the microscope system 10 is internally provided with the CCD sensor 20, similar advantages may be achieved when a detachable CCD sensor is utilized, instead. Such a microscope system may be constituted by mounting, for instance, a digital camera having an image-capturing element such as a CCD sensor at an eyepiece unit or the like of a microscope. Since the electronic zoom magnification factor for the CCD sensor is controlled by the controller 29, the digital camera (CCD sensor) must include a digital control terminal (an RS232C, a USB or the like) in this case.

The present invention may also be adopted in a structure achieved by providing an optical zoom mechanism between the objective lens and the image-capturing element. In this case, the magnifying power of the objective lens, the magnification factor achieved through the optical zoom and the electronic zoom magnification factor must be adjusted.

Now, in reference to FIGS. 8˜10, the moving mechanism for the microscope system mentioned earlier is explained in detail. The same reference numerals are assigned to components in FIGS. 8˜10 that are identical to those in FIG. 1 to preclude the necessity for a repeated explanation thereof.

### x Y Moving Mechanism for Moving the Specimen 11

As illustrated in FIGS. 8˜10, an X-direction linear guide 202 is provided at a base board 201 inside the casing 500, with the motor-driven stage 12x mounted at the X-direction linear guide 202 in such a manner that the motor-driven stage 12x can be moved by an X-direction drive motor 203 along the X direction. A Y-direction linear guide 204 is provided at the motor-driven stage 12x, with the motor-driven stage 12y mounted at the Y-direction linear guide 204 in such a manner that it can be moved by a Y-direction drive motor 205 along the Y direction. The X-direction drive motor 203 and the Y-direction drive motor 205 are driven in response to a command signal provided by the stage control circuit 24 shown in FIG. 1.

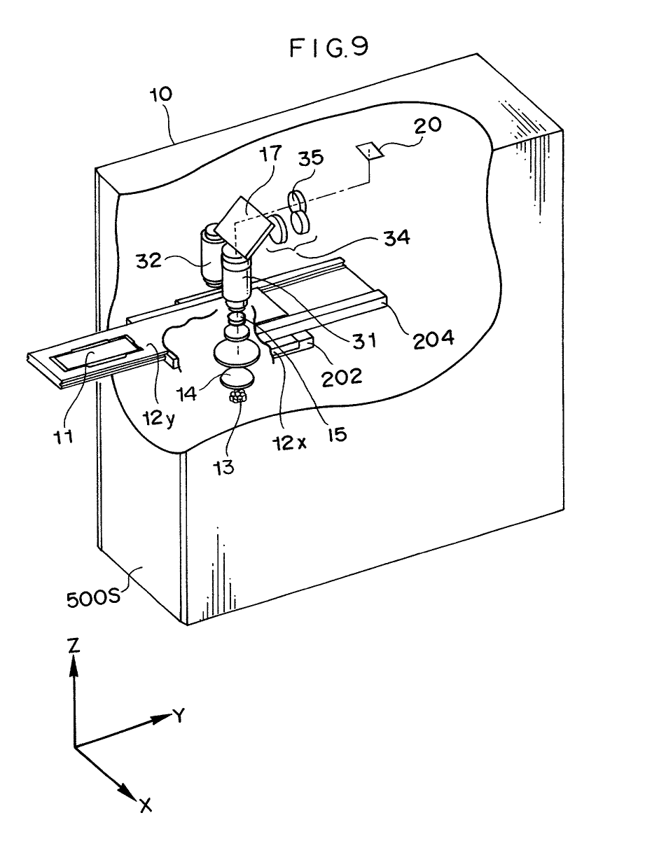

The specimen 11 is moved along the X direction and the Y direction as explained below by the X Y moving mechanism for moving the specimen 11 structured as described above. Namely the specimen 11 can be moved along the X direction as shown in FIG. 8 by driving the motor-driven stage 12x along the X direction with the X-direction drive motor 203. The specimen 11 can also be moved along the Y direction as shown in FIG. 8 by driving the motor-driven stage 12y along the Y direction with the Y-direction drive motor 205. The specimen 11 is set by allowing the motor-driven stage 12y to project out from a side surface 500s of the casing 500 as shown in FIG. 9. The mechanism may assume a structure which allows the stages 12x and 12y to be driven manually instead.

### XZ Moving Mechanism for Moving the Objective Lens Unit 16

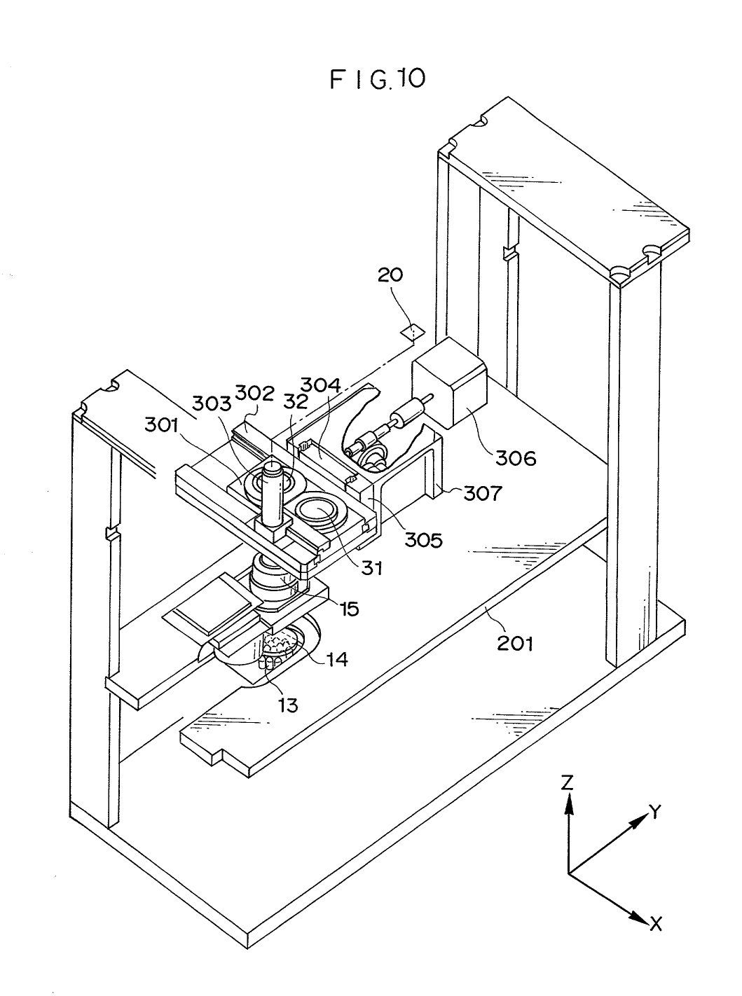

As shown in FIGS. 8 and 10, the objective lenses 31 and 32 are supported by a holder 301. The holder 301 is provided at an X-direction linear guide 302 in such a manner that the holder 301 can be moved along the X direction by an X-direction drive motor 303. The X-direction linear guide 302 is provided at a Z-direction linear guide 305 via a block 304 in such a manner that it can be moved by a Z-direction drive motor 306 along the Z direction. As shown in FIG. 10, the Z-direction linear guide 305 is supported by a holding block 307. The X-direction drive motor 303 and the Z-direction drive motor 306 are driven in response to a command signal provided by the objective lens drive circuit 25 shown in FIG. 1.

The objective lenses 31 and 32 are moved along the X direction and the Z direction as explained below by the X Z moving mechanism for moving the objective lens unit 16 structured as described above. Namely, by driving the holder 301 along the X direction with the X-direction drive motor 303, either of the objective lens 31 and the objective lens 32 is set at the observation optical path 10a or is moved out of the observation optical path 10a. By driving the X-direction linear guide 302 along the Z direction via the block 304 with the Z-direction drive motor 306, the objective lens 31 or the objective lens 32 can be moved along the Z direction for a focal adjustment.

### X Moving Mechanism for Moving the Tube Lens Unit 18

The tube lenses 34 and 35 shown in FIG. 9 are supported by a holder 401 as illustrated in FIG. 8. The holder 401 is provided at an X-direction linear guide 402 in such a manner that the holder 401 can be moved along the X direction by an X-direction drive motor (not shown). The X-direction linear guide 402 is mounted at a base board (not shown). The X-direction drive motor (not shown) is driven in response to a command signal provided by the tube lens drive circuit 26 shown in FIG. 1.

The tube lenses 34 and 35 are moved along the X direction as explained below by the X moving mechanism for moving the tube lens unit 18 structured as described above. Namely, by driving the holder 401 along the X direction with the X-direction drive motor (not shown), the tube lens 34 or 35 is set at the observation optical path 10a or is moved out of the observation optical path 10a. While the objective lenses 31 and 32 and the tube lenses 34 and 35 are moved by utilizing electrical motors in the example discussed above, they may be manually operated instead. Instead of the X moving mechanism for moving the objective lens unit 16, a rotary revolver mechanism having a plurality of objective lenses provided along the circumferential direction may be utilized.

What is claimed is;

1. A microscope system comprising:
an optical system holding member that holds a plurality of optical systems with different magnifying powers and inserts one of the plurality of optical systems at an optical path;
an image-capturing element that captures an image of a specimen formed by the optical system and outputs an image signal;
a setting device that sets an electronic zoom magnification factor for the specimen image captured by the image-capturing element; and
a control device that generates a specimen image at a display magnification factor by using the image signal output from the image-capturing element based upon the magnifying power of the optical system inserted at the optical path for specimen observation and the electronic zoom magnification factor.

2. A microscope system according to claim 1, further comprising:
an input device through which a specific value for the display magnification factor at which the specimen image is to be displayed is input; and
an inserting device that inserts the optical system selected for specimen observation at the optical path by driving the optical system holding member, wherein:
the control device controls the inserting device and the setting device so as to match the display magnification factor with the specific value input through the input device.

3. A microscope system according to claim 2, wherein:
the control device selects a magnifying power with a value smaller than and closest to the specific value from the various magnifying powers of the plurality of optical systems and calculates a ratio of the selected optical magnifying power and the specific value as the electronic zoom magnification factor.

4. A microscope system according to claim 2, further comprising:
a correction device that, when the optical system inserted at the optical path is replaced with another optical system, corrects a decentering misalignment of the image occurring between the original optical system and the replacement optical system.

5. A microscope system according to claim 4, further comprising:
a storage device that stores in memory a plurality of decentering misalignment quantities each corresponding to one of the plurality of optical systems.

6. A microscope system according to claim 5, wherein:
positions at which images of a reference mark to be captured are formed by the plurality of optical systems respectively are detected and a deviation between the positions at which the images are formed by the optical systems and a center of an image capturing screen are stored in the storage device as the decentering misalignment.

7. A microscope system according to claim 5, wherein:
if the plurality of optical systems are not exchangeable, the extents of decentering misalignment manifesting at the optical systems, which have been measured, and stored in memory in advance at the storage device.

8. A microscope system according to claim 1, wherein:
a maximum value for the electronic zoom magnification factor is set equal to a ratio of the two closest magnifying powers among the magnifying powers of the plurality of optical systems.

9. A microscope system according to claim 1, wherein:
a display image of the specimen is generated by using an image signal read out over a readout range which corresponds to the electronic zoom magnification factor.

10. A microscope system according to claim 1, wherein:
a display image of the specimen is generated by first temporarily storing in memory image signals read out from the image-capturing element and then reading out an image signal over a range corresponding to the electronic zoom magnification factor among the image signals read out from a memory.

11. A microscope system comprising:
an optical system holding member that holds a plurality of optical systems with different magnifying powers and inserts one optical system among the plurality of optical systems at an optical path;
an image-capturing element that captures an image of a specimen formed by the optical system and outputs an image signal;
an input device through which a specific value for a magnification factor at which the specimen image is to be magnified is input;
an arithmetic operation device that calculates an electronic zoom magnification factor for the specimen image by ascertaining the magnifying power of the optical system inserted at the optical path based upon the specific value input through the input device and the magnifying power of the optical system having been ascertained; and
a control device that generates a specimen image at a display magnification factor by using the image signal output from the image-capturing element based upon the electronic zoom magnification factor calculated by the arithmetic operation device.

12. A microscope comprising:
a mounting unit at which an image-capturing device is mounted;
an optical system holding member that holds a plurality of optical systems with different magnifying powers and inserts one optical system among the plurality of optical systems at an optical path;
an input device through which a specific value for a display magnification factor at which a specimen image is to be displayed is input;
an arithmetic operation device that calculates an electronic zoom magnification factor for the specimen image based upon the specific value input through the input device and the magnifying power of the optical system inserted at the optical path to form the specimen image on the image capturing device; and
a control device that generates a specimen image at the display magnification factor that has been input by using the image signal output from the image-capturing device based upon the electronic zoom magnification factor calculated by the arithmetic operation device.

13. A microscope comprising:
a mounting unit at which an image-capturing device is mounted;
an inserting device that inserts one optical system among a plurality of optical systems with different magnifying powers for forming a specimen image on the image-capturing device at an optical path;
an input device through which a specific value for a display magnification factor at which the specimen image is to be displayed is input;
an arithmetic operation device that selects one of the plurality of optical systems based upon the specific value input through the input device and calculates an electronic zoom magnification factor for the specimen image based upon the magnifying power of the optical system having been selected and the specific value having been input; and
a control device that controls the inserting device so as to allow the selected optical system to be inserted at the optical path and generates a specimen image at the display magnification factor by using an image signal output from the image-capturing device, based upon the electronic zoom magnification factor calculated by the arithmetic operation device.

14. An image capturing method adopted in a microscope that displays a specimen image at a display magnification factor achieved based upon an optical magnification factor of an optical system and an electronic zoom magnification factor set for an image-capturing device, comprising:
obtaining the display magnification factor;
selecting the optical system to be utilized based upon the display magnification factor that has been obtained;
calculating the electronic zoom magnification factor based upon the optical magnification factor of the optical system having been selected and the display magnification factor having been obtained; and
generating a specimen image at the display magnification factor having been obtained by using an image signal constituting the specimen image output from the image-capturing element.
